(19) United States
(12) Patent Application Publication
(10) Pub. No.: US 2011/0138429 A1
(43) Pub. Date: Jun. 9, 2011

(54) SYSTEM AND METHOD FOR DELIVERING SELECTIONS OF MULTI-MEDIA CONTENT TO END USER DISPLAY SYSTEMS

(75) Inventors: Barton Price Schade, Solana Beach, CA (US); Jarrod Robert Hammes, San Diego, CA (US); Robert Coackley, Pleasanton, CA (US)

(73) Assignee: IP Video Networks, Inc., San Diego, CA (US)

(21) Appl. No.: 12/939,140

(22) Filed: Nov. 3, 2010

Related U.S. Application Data
(60) Provisional application No. 61/272,802, filed on Nov. 4, 2009.

(51) Int. Cl. H04N 7/173

(52) U.S. Cl. 725/98; 725/110

(57) ABSTRACT

This disclosure provides systems, methods and apparatus for providing user selected IP Data Network Protocol multi-media content via a CATV communication channel. In one example, a method of providing multi-media content includes receiving control data at a cable television provider server system from an controller device at an end-user location via an IP Data Network, the controller device having a display screen, a user interface, and at least one processor, and being configured to send and receive signals from the IP Data Network, where the control data indicating multi-media content to be provided by the provider system to a display system at the end-user location. The method can include retrieving to the server system the indicated multi-media content, converting the multi-media content from an IP Data Network format to a data format suitable for delivery by the provider system through a cable television communication channel of a CATV network to the display system, and providing from the server system the converted multi-media content through the cable television communication channel of a CATV network to the display system.

### CROSS-REFERENCE TO RELATED APPLICATIONS

This application claims the benefit of U.S. Provisional Application Ser. No. 61/272,802, filed on Nov. 4, 2009, which is hereby incorporated by reference in its entirety.

### BACKGROUND OF THE INVENTION

1. Field of the Invention

The present invention relates to broadcasting multi-media content on a cable TV (CATV) communication channel. More particularly, the present invention relates to sourcing content from IP Data Network locations and delivering such content via a cable television system for viewing on end user television display systems.

2. Description of the Related Art

In a conventional cable television system, video content is provided by a cable system operator for viewing by end users. The video content is typically provided on a scheduled basis. Recently, however, Internet Protocol Television (IPTV) services enabling the transmission and reception of broadcast signals in Internet Protocol (IP) packets can be provided on the cable television cable but on an IP Data Network communication path (which uses, e.g., different data formats and/or communication protocols). This has enabled the delivery of IP based video content to Personal Computers (PCs), laptops, and mobile devices such as cell phones and portable computer tablets in residences and other end-user locations that are in communication with a cable television system. IP based video services now extend beyond traditional television programming services and allow end users to view an almost unlimited array of multi media content. The Internet is defined as a worldwide, publicly accessible series of interconnected computer networks that transmit data by packet switching using the standard Internet Protocol (IP).

Also various methods have been developed for connecting PC devices, including laptops and mobile devices, to television receivers for viewing of Internet videos on television receivers using additional Customer Premises Equipment (CPE).

One method for delivering content available from an IP Data Network (e.g., the Internet) to a television receiver includes having additional CPE (at the end user location) that converts the output from a computer to the television. A second method is for the television to have an Internet connection and also have an internal capability for sourcing video content through the Internet connection. This second method is a restricted service that limits Internet sources to sources defined by the television manufacturer. In the first case, the use of additional equipment introduces problems in cabling or technical issues which can sometimes be very inconvenient or difficult for end users to handle. In the second case, the partial access to the Internet can be very frustrating to end users and the TV integrated computer adds cost, the need for software updates, the inevitability of hardware obsolescence and added complexity.

### SUMMARY OF THE INVENTION

The systems, methods and devices of the disclosure each have several innovative aspects, no single one of which is solely responsible for the desirable attributes disclosed herein.

Methods and systems of this inventions allow an end-user to watch high quality renderings of IP Data Network multi-media content on a display system (for example, a television) at an end-user location where the IP Data Network multi-media content (also referred to as is IP Data Network content) provided to the end-user display system from a multiple services operator (MSO) on a cable television (CATV) communication channel. The IP Data Network content can be, for example, multi-media content available from the Internet by an Internet resource. One example of this invention is a server system at the MSO that is configured to have interactive real-time video format adaptation (VFA) functionality, for example, the server system can have a VFA module. VFA functionality can adapt IP Data Network content for presentation as a “live” event on a television subscriber's channel. A VFA configured server can extract multi-media content from, for example, an Internet resource, in an IP Data Network transmissible format. The VFA functionality can repackage the IP Data Network transmissible format multi-media content in a transport stream format suitable for transmission over a cable television communication network (e.g., MPEG-TS). The VFA functionality may also process and selectively repackage the multi-media content at a higher quality than the original signal, such as higher resolution or higher bit rate. The VFA functionality may also selectively format the content for differing display aspect ratios, such as 16:9.

In some embodiments, the VFA functionality can be implemented using a client/server architecture. The client software runs on the end user's controller device, an IP Data Network capable device having a display screen and a processor, capable of displaying multimedia content and capable of sending and receiving signals over an IP Data Network (e.g., the Internet). Examples of controller devices include a personal computer, laptop computer, a tablet computer (e.g., an iPad), and a mobile communication device. A server at the CATV provider can be configured to run VFA software that runs within the internal network of the multi-system operator (MSO). The client application sends various control data and/or commands to the VFA server through the IP Data Network, and receives responses from the VFA server. In addition, in response to the client application's communications the MSO provides selected multi-media content to a display system at an end-user location on a cable television communication channel, e.g., in MPEG-2 or MPEG4 video format. The display system includes a receiver (e.g., a set-top box) that can decode the received video and it can then be displayed on a display screen of the display system.

One innovative aspect of the subject matter described in this disclosure can be implemented in a method of providing multi-media content, includes receiving control data at a server system of a cable television provider system (for example, an MSO) through an IP Data Network from a controller device at an end-user location, the controller device having a display screen and at least one processor, and the controller device being configured to present multi-media content on the controller screen and to transmit and receive signals from an IP Data Network, wherein the control data indicates multi-media content to be provided by the provider system to a display system at the end-user location, retrieving to the server system the indicated multi-media content, converting the multi-media content from an IP Data Network format to a data format suitable for delivery by the provider system through a cable television communication channel of a CATV network to the display system, and providing from the server system the converted multi-media content through the cable television communication channel of a CATV network to the display system. In some embodiments the converted multi-media content is provided to a set-top box of the display system. The data format suitable for delivery by the provider system through a cable television communication channel of a CATV network may be Moving Picture Experts Group-2 (MPEG-2-1) format. In certain embodiments, the method includes converting the multi-media content to MPEG-2 format video, and providing the converted multi-media content includes providing the MPEG-2 video to a set-top box in the display system at the end-user location. In some aspects, the video codec format suitable for delivery by the provider system through a cable television communication channel of a CATV network comprises H.264/Moving Picture Experts Group-4 format. In some methods the converted multi-media content is provided to the display system in a Moving Picture Experts Group-2 (MPEG-2-1) System Layer Transport Stream (TS). In some embodiments, the IP Data Network comprises the Internet. In some embodiments, the control device comprises any one of a laptop computer, a tablet computer, and a mobile device. In some embodiments, the method can also include receiving control data at the server system from the controller device through a communication path that does not include a set-top box of the display system, and in other embodiments the communication path includes the set-top box. In one aspect the control data indicates where the multi-media content is available on the IP Data Network, for example, the control data can include or indicates a Uniform Resource Identifier (URI) where the multi-media content can be retrieved.

In some embodiments of a method of providing multi-media content, retrieving the indicated multi-media content includes retrieving the multi-media content via the IP Data Network. Some embodiments further include providing a client application to the controller device for providing the control data to the multiple services operator. In some embodiments of the method, receiving control data includes receiving the control data from the client application running on the controller device. In some embodiments, the method further includes generating on the controller device the control data indicating the selected multi-media content for the provider system to provide to the display system at the end-user location, sending the control data to the provider system via the IP Data Network; and receiving on the display system the converted multi-media content from the provider system. In some embodiments, receiving on the display system includes receiving the converted multi-media content in MPEG-2 format at the display system at the end-user location. In some embodiments, said receiving includes receiving the converted multi-media content in MPEG-2 format at a set-top box in the display system at the end-user location. Any of the methods can further comprise displaying the multi-media content on a display screen of the display system at the end-user location. In some embodiments, the multi media content is provided to the display system though a connected video-on-demand (VOD) channel in real-time.

Another innovative aspect can be implemented in a system for providing multi-media data to an end user receiver, the system including a display system at an end-user location, the display system comprising a receiver capable of receiving multi-media content from a cable television communication channel of a CATV network, a controller device at an end-user location, the controller device having at least one processor and a display screen for displaying multi-media content and configured to transmit and receive signals from an IP Data Network, the controller device further configured to generate control data indicating selected multi-media content to be provided to the display system and provide the control data over the IP Data Network to, and a server system in a cable television provider system, the server system having a receiving module configured to receive control data via an IP Data Network, the control data indicative of selected multi-media content to be provided by the provider system to the display system, and a controller module configured to receive the selected multi-media content from the IP Data Network, convert the multi-media content from an IP Data Network format to a data format suitable for delivery by the provider system through a cable television communication channel, and provide the converted multi-media content through the cable television communication channel of the CATV network to the display system. In one embodiment, the controller module comprises an input streaming, a multimedia cache, video engine ingress, the video application processing engine, image processing, the SDV VOD interface, and video engine egress. In some examples the display system includes a set-top box comprising the receiver. The display system can have a display screen connected to the set-top box, the display screen configured to display multi-media content provided by the set-top box to the display screen. The data format suitable for delivery by the provider system through a cable television communication channel of a CATV network can include Moving Picture Experts Group-2 (MPEG-2) format and/or H.264/Moving Picture Experts Group-4 format. In some exemplary systems the controller module is configured to convert the multi-media content to MPEG-2 format video and provide the multi-media content in MPEG-2 format video to a set-top box of the display system. In some aspects, the format suitable for delivery by the provider system through a cable television communication channel of a CATV network comprises Moving Picture Experts Group-2 (MPEG-2-1) System Layer Transport Stream (TS) format. The controller device includes any one of a laptop computer, a tablet computer, and a mobile device, and in some examples multiple controller devices are used to select multi-media content to be provided to the end-user display system.

In some examples, the display system includes a set-top box, and wherein the controller device is configured to provide the control data to the cable television provider system through a communication path that does not include a set-top box of the display system. In other examples, the display system comprises a set-top box, and wherein the controller device is configured to provide the control data to the cable television provider system through a communication path that includes a set-top box of the display system. In any of these systems or methods the control data can indicate a Universal Resource Identifier (URI) where at least a portion of the selected multi-media content can be retrieved. The controller device can include a client application for providing the control data to the multiple services operator, and the client application can be downloaded from the CATV provide system. In some examples, cable television provider system is configured to provide the selected multi media content to the display system through a connected video-on-demand (VOD) channel in real-time. The control data can include end-user information, and the server system at the cable provider (or MSO) is configured to validate the end-user information. The server system can also be configured to validate at least one URI indicated by the control data.

Another innovative aspect can include a tangible computer readable medium having instructions stored thereon, the instructions including instructions for receiving control data at a server system of a cable television provider system via an IP Data Network from a controller device at an end-user location, the controller device having a display screen and at least one processor, and the controller device being configured to present multi-media content on the controller screen and to transmit and receive signals from an IP Data Network, wherein the control data indicates multi-media content to be provided by the provider system to a display system at the end-user location, instructions for retrieving to the server system the indicated multi-media content, instructions for converting the multi-media content from an IP Data Network format to a data format suitable for delivery by the provider system through a cable television communication channel of a CATV network to the display system, and instructions for providing from the server system the converted multi-media content through the cable television communication channel of a CATV network to the display system.

Another innovative aspect can be implemented in a system for providing multi-media data to an end user receiver, the system including means-for receiving control data at a server system of a cable television provider system via an IP Data Network from a controller device at an end-user location, the controller device having a display screen and at least one processor, and the controller device being configured to present multi-media content on the controller screen and to transmit and receive signals from an IP Data Network, wherein the control data indicates multi-media content to be provided by the provider system to a display system at the end-user location, means-for retrieving to the server system the indicated multi-media content, means-for converting the multi-media content from an IP Data Network format to a data format suitable for delivery by the provider system through a cable television communication channel of a CATV network to the display system, and means-for providing from the server system the converted multi-media content through the cable television communication channel of a CATV network to the display system.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is an overview of the disclosed system.

FIG. 2 is a detailed view of the high-level components of the disclosed system.

FIG. 3a is a process diagram illustrating the steps of system operation.

FIG. 3b is a second process diagram illustrating the steps of system operation using sharing credentials.

FIG. 4 is an example of a user interface for an interface to generate signals to the system.

FIG. 5 is a state diagram illustrating the client disposition and the conditions changing the client disposition.

FIG. 6A is a server sub-system component level diagram.

FIG. 6B is a process flow diagram illustrating one method of a server operation.

FIG. 7 is a process diagram illustrating the video buffer pipeline.

FIG. 8 is a state diagram illustrating the server disposition and the conditions changing the server disposition.

FIG. 9 is a process diagram illustrating one method of transcoding content from an Internet signal to a television signal.

### DETAILED DESCRIPTION OF THE PREFERRED EMBODIMENT

The following detailed description is directed to certain implementations for the purposes of describing the innovative aspects. However, the teachings herein can be applied in a multitude of different ways. Embodiments of the invention include systems, methods and apparatus for providing user selected IP Data Network Protocol multi-media content via a CATV communication channel. For example, a system can include an IP Data Network connected device that controls, transcodes, and delivers video content to a cable television network for delivery of user selected programming to a television receiver, where the user selected programming is multi-media content from an IP Data Network.

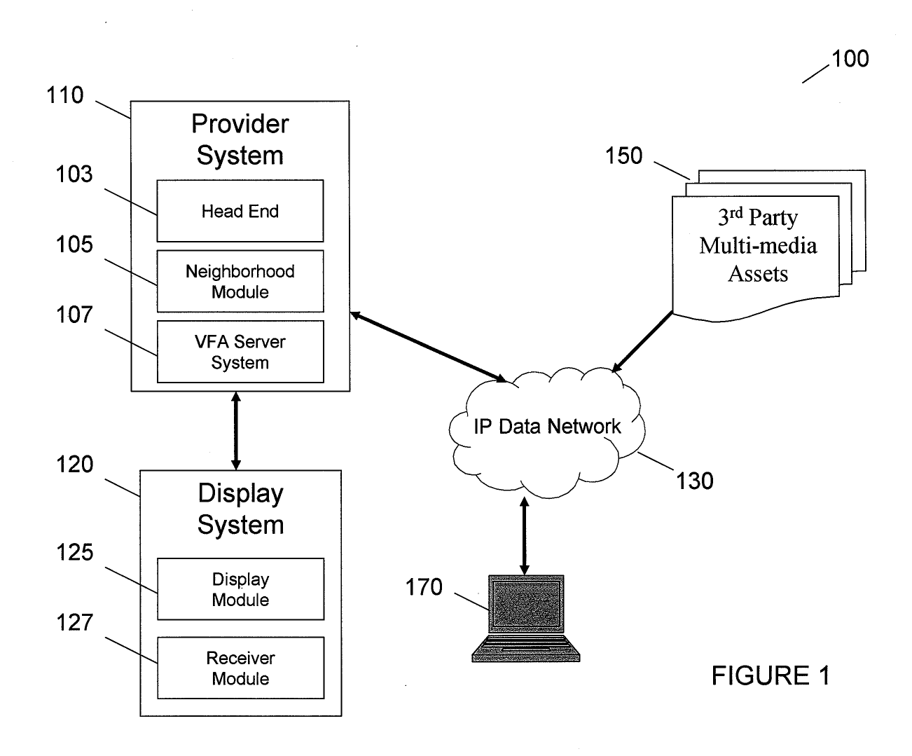

One embodiment of the invention is illustrated in FIG. 1, which shows a system 100 configured to deliver selections of multi-media content to an end user display system 120. The system 100 includes a cable television (CATV) provider system 110, which is operated by a cable television company. The provider system 110 includes a communication network that is configured to provide to an end-user location (e.g., a subscriber's residence) a communication channel that provides CATV programming content and a communication channel that provides two-way access to an IP Data Network (e.g., the Internet) over the same physical communication means (e.g., a coax cable wire, optical fiber, or wireless system, including satellite). Such cable companies are sometimes referred to herein as a multiple services operator or “MSO.” The provider system 110 includes a head-end 103 located at a CATV facility that originates and communicates CATV services and cable modem services to subscribers. The head-end 103 can include other equipment for providing services, including an antenna and other wired and wireless communication connections for receiving incoming content, which it then distributes to its subscribers in one or more programming packages. The headend can also contain persistent storage media containing video archives. Most communication between the provider system 110 and a subscriber and is “downstream” from the cable head-end 103 to subscribers, however, CATV systems can also provide communications “upstream,” for example, when a subscriber requests a pay-per-view program. In one embodiment, the VFA Server 107 may be configured to access headend local multi-media assets for advertisement insertion, local programming playout, viral cached video, and traditional VOD. This enables expansion of services and sources for providing content. It will be appreciated to one of ordinary skill in the art, that while the current embodiment describes a system using cable television as part of the provider system, other means such as satellite, may be utilized as part of the provider system to obtain the same result.

When a cable company also provides its subscribers access to a IP Data Network the head-end 103 can include specific components such as additional server systems and databases to facilitate such Internet access. The head-end can also include a cable modem termination system (CMTS), which sends and receives digital signals to a subscribers' cable modem using the existing cable network, to provide IP Data Network services to cable subscribers.

The provider system 110 can also include one or more neighborhood modules 105 that receive programming content from a head-end and re-transmit such programs to at least one subscriber display system 120 at an end-user location. The neighborhood module may also be referred to as a hub. The neighborhood modules 105 are typically located closer in proximity to the subscribers (e.g., in a residential neighborhood which receives cable services). The re-transmission may include using digital transmission technologies such as MPEG-2 or other suitable transmission protocols.

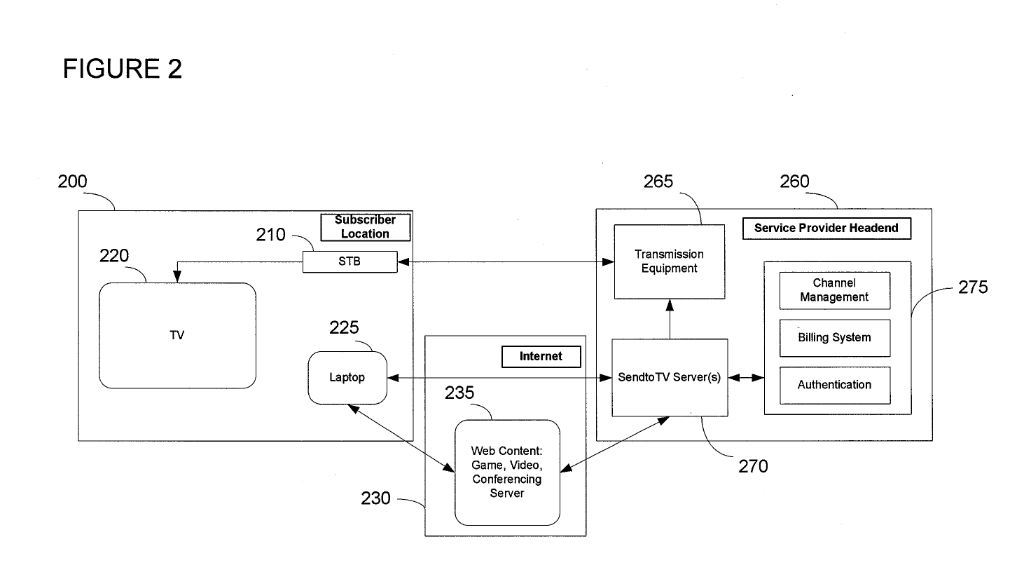

The provider system 110 may also include administrative modules, further described in reference to FIG. 2, for handling a number of tasks associated with providing cable services, for example, billing, tracking, and authenticating use of the cable service. A billing module, can, for example, allow the operator to bill subscribers who request pay-per-view programming. A provider system 110 can also use an authentication module to ensure only authorized subscribers access content from the provider system 110.

Still referring to FIG. 1, in some embodiments the provider system 110 also includes a server system 107 configured to receive and convert user selected multimedia content from an IP Data Network format to a video format that is suitable for transmission on a CATV communication channel (e.g., in MPEG-2 or MPEG4 format). Such a server system is sometimes referred to herein as a Video Format Adapter server (“VFA Server”). In some embodiments, the VFA Server 107 is a separate apparatus, or includes more than one apparatus, that is included in the provider system 100. In some embodiments, the VFA Server 107 functionality is embodied in one or more software modules in the provider system 110, or it can be implemented in a combination of hardware and software. For example, the VFA Server 107 can be implemented in software running on a multi-threaded parallel processor computing device. In some embodiments, the VFA Server 107 may be implemented in software running on a virtual machine hosted on one or more multi-threaded parallel processor computing devices. The host for the virtual machine may be co-located with the provider system 110, or at a remote hosting facility (not shown) connected to the provider system 110 via an IP Data Network 130. In some embodiments, the VFA Server 107 is implemented in hardware, such as a network-appliance.

The system 100 also includes a controller device 170, described in further detail below. The VFA Server 107 is configured to receive control data indicating requests of end-user selected multi-media content 150 which is available from a 3^{rd} party IP Data Network resource. In some embodiments, the control data is sent over an IP Data Network 130 from the controller device 170 for user selected multi-media content 150. The control data contains information needed to locate the selected multi-media content 150. For example, the control data can include a uniform resource identifier (URI), uniform network name (URN), uniform resource link (URL), a universally unique identifier (UUID), and/or a globally unique identifier (GUID), to locate the multimedia content 150. The controller device 170 can provide information affecting the playback of the selected multi-media content.

In certain embodiments, the controller device 170 can provide information about the controller device 170, the end-user location of the display system 120, or the subscriber requesting the multi-media content. For example, the controller device 170 can be configured to send information identifying capabilities of the controller device 170, for example, that the controller device 170 is a smartphone, or display capabilities of the controller device 170. The controller device 170 is further configured to selectively transmit data similar to web browser cookies. Examples of cookie data use include authentication, storing preferences, or server session identification.

In the embodiment illustrated in FIG. 1, the system 100 also includes a display system 120. The display system 120 is physically located at an end-user location such as a residence or a commercial establishment. The display system 120 includes a receiving module 127 for receiving multi-media content from the provider system 110. The receiving module 127 selectively performs other functions such as recording content, storing content, encoding or decoding content, or transforming content. In one embodiment, the receiving module 127 is a stand alone piece of hardware enabling the reception of content from a provider, for example, a set-top box. The functions performed by the set-top box may be implemented through software executed by a programmable microprocessor or as hardware functions.

The display system 120 also includes a display module 125 for displaying the multi-media content received. The display module 125 can include a plurality of inputs and a display screen. The inputs are used to receive the transmitted multi-media content. In some examples, inputs can include s-video, high-definition multi-media interface, RGB, VGA, or other suitable multi-media signal input formats. The display module 125 receives the transmission through an input and renders the video. A display module 125 may also contain an audio output module. The audio output module broadcasts the corresponding sound for the rendered video. In one embodiment, the audio and video are played using different devices. For example, the video signal may be displayed on the display screen while the sound is played using a separate home theater surround sound stereo component. In other embodiments, the audio and video are played by the same device.

The functionality of the display module 125 and receiver module 127 may be combined into a single display device of the display system 120. In certain embodiments, the receiver module functionality may be implemented as an embedded hardware device connected to the display device. In some embodiments, the receiver functionality may be implemented as software executed by a processor running on the display device.

Still referring to FIG. 1, the system 100 also includes a controller device 170. Generally, the controller device 170 is located at the same end-user location as the display system 120 so that an end-user using the controller device 170 requests multi-media content to be provided to the co-located display system 120 for viewing, for example, on a larger display screen so multiple people can easily view it. However, the controller device 170 need not be located at the same end-user location as the display system 120. The controller device 170 has at least one processor. The processor may be single threaded or multi-threaded. The controller device 170 may have multiple processors. In a multi-processor embodiment, each processor may be single threaded or multi-threaded and further configured to work independently or in parallel.

The controller device 170 also has a display screen capable of displaying multi-media content. The controller device 170 may have an embedded display screen, such as a smartphone or a laptop. The controller device 170 may have an attached display screen, such as a desktop personal computer coupled to a monitor.

The controller device 170 is configured to transmit and receive signals to and from an IP Data Network 130. An example of an IP Data Network 130 is the Internet. The controller device 170 is configured to transmit and receive signals in compliance with the networking protocol of the IP Data Network 130 the controller device 170 to which it has established a communication link. The controller device 170 may be configured to connect directly to the IP Data Network 130 via one or more wires, such as a category 5 Ethernet cable. The controller device 170 may be configured to connect directly to the IP Data Network 130 using a wireless network connection.

The controller device 170 may connect to the IP Data Network several ways. The controller device 170 may connect to the IP Data Network 130 using a cable modem. In another embodiment, the controller device 170 connects to the IP Data Network 130 using a digital subscriber line (DSL). In another embodiment the controller device 170 connects to the IP Data Network 130 using a wireless link (known as “WiFi). In yet another embodiment, the controller device 170 connects to the IP Data Network 130 using a modem connected to a phone.

The controller device 170 is further configured to generate control data indicating selected multi-media content to be provided to the display system 120. In some embodiments, the controller device 170 is configured to control the playback of the selected multi-media content on the display system 120 by providing playback control data over the IP Data Network 130 to the provider system 110. In one embodiment, the controller device 170 contains software executed using a processor on the controller device 170. The software receives user inputs, translates the inputs to control data, and transmits the control data to the provider system 110. In one embodiment, the controller device 170 is configured to transmit the control data directly to the Video Format Adapter server of the provider system 110. In another embodiment, the controller device 170 is configured to transmit the control data to an intermediary at the provider system 110. The intermediary may then transmit the control data to the VFA Server or to a subsequent intermediary. In this way, the provider system 110 may be configured to chain multiple intermediaries to achieve a desired result. Intermediaries may include, but are not limited to, authentication modules, validation modules, billing modules, load balancing modules, caching modules, fetching modules, pre-fetching modules, data mining modules, or content filtering modules.

The system is further configured to connect with multi-media content 150 available via IP Data Network 130. Multi-media content 150 can be stored at a host system. Storage of the multi-media content 150 may be distributed, such as across multiple servers on a peer-to-peer network.

The multi-media content 150 may be stored as a specified media type. Examples of multi-media content includes but is not limited to single frame images or pictures, video, animation, text, presentation files, and audio. Formats of multi-media content and includes but is not limited to formats of MP3, MPEG video, AVI, QuickTime, and Flash. Multimedia content may be gaming systems user interface in form of video.

The system utilizes an IP Data Network 130. An example of an IP Data Network 130 is the Internet. The IP Data Network 130 may be a public network, like the Internet. The IP Data Network 130 may be a private network with access limited to cable subscribers only.

The IP Data Network 130 provides a standard mechanism for exchanging packets of data between senders and receivers. One such mechanism is Transmission Control Protocol/Internet Protocol (TCP/IP). The IP Data Network may be configured to support multiple protocols. The IP Data Network may be further configured to support multiple versions of each protocol.

One path utilizing the IP Data Network is the communication from the controller device 170 to identify multi-media content 150. A second path utilizing the IP Data Network 130 is the communication from the controller device 170 to the provider system 110, and more specifically the VFA Server 107. A third path utilizing the IP Data Network 130 is the access and retrieval of the multi-media content 150 by the provider system 110, and more specifically by the VFA Server 107. In an alternate embodiment, a fourth communication path from the host of the multi-media content 150 to the controller device 170 over the IP Data Network 130 is used.

Accordingly, embodiments include methods and systems that provide for delivery of all existing cable television programs as well as any selected video content from an IP Data Network (e.g., the Internet) without any special apparatus or changes at the end user premises so that an end user existing display system (e.g., set-top box and television) can be used to show high quality presentation of the selected video content at a television receiver. Such systems and methods also allow the normal use of additional devices such as Digital Video Recorders at the end user premises without modification or changes in operating instructions to the end user.

FIG. 2 shows a view of some high-level components of a system. The system has at least three locations of interest, subscriber location 200, Internet 230, and service provider head-end 260. A subscriber location 200 corresponds to a subscriber's location, such as a residence or commercial establishment. For example, at a subscriber location or home location 200, there will be a set-top box (STB) 210, a display device 220, and a controller device 225. The controller device 225 contains a display screen and at least one processor. The controller device 225 is further configured to present multi-media content on the controller screen and to transmit and receive signals from an IP Data Network, such as the Internet 230. In one embodiment, the controller device 225 is a personal computer. In another embodiment, the controller device 225 is a smartphone. More specifically, the controller device 225 transmits and receives signals with web content providers 235 and the VFA server 270 at the service provider head-end 260. An Internet 230 location corresponds to the location of various content providers 235. The content providers 235 host multi-media content and other web-accessible assets.

At the service provider head-end 260 location, a multi-system operator maintains transmission equipment 265, one or more VFA servers 270, and assorted administrative and infrastructure components 275. The transmission equipment 265 sends content to a STB 210 in a subscriber location 200 for viewing at a display device 220. The transmission equipment uses a cable television content channel to deliver the content. Video on demand channel is an example of such a channel. Connected to the transmission equipment 265, is one or more VFA servers 270. In a second embodiment, the transmission equipment 265 and the VFA server 270 are a single piece of equipment. The VFA server 270 accesses and transforms web-content from third-party asset locations 235. The VFA server 270 is configured to directly access content. The VFA server 270 is also configurable to allow access to protected content by establishing a trusted relationship between the VFA Server 270 and the content host 235. Alternatively, the VFA server 270 may store user information for a given subscriber and use this user information to access the content 235. The VFA server 270 is further configured transform the web-content for display at the end user's display system. Transformations are selectively applied to the video and audio components of the content. Examples of video transformations include changing the bit rate, aspect ratio, or colorspace. Examples of audio transformations include changing the bit rate, normalization, equalization, or gain.

The VFA server 270 is further configured to transmit the transformed web-content to the transmission equipment 265. In one embodiment, the transmission is achieved through a wired connection between the VFA server 270 and the transmission equipment 265. In another embodiment, the transmission is accomplished through a wireless connect between the VFA server 270 and the transmission equipment 265.

The VFA server 270 is additionally configured to access the various administrative and infrastructure components 275 at the service provider head-end 260. Examples of the administrative and infrastructure components 275 include channel management, billing, and authorization module.

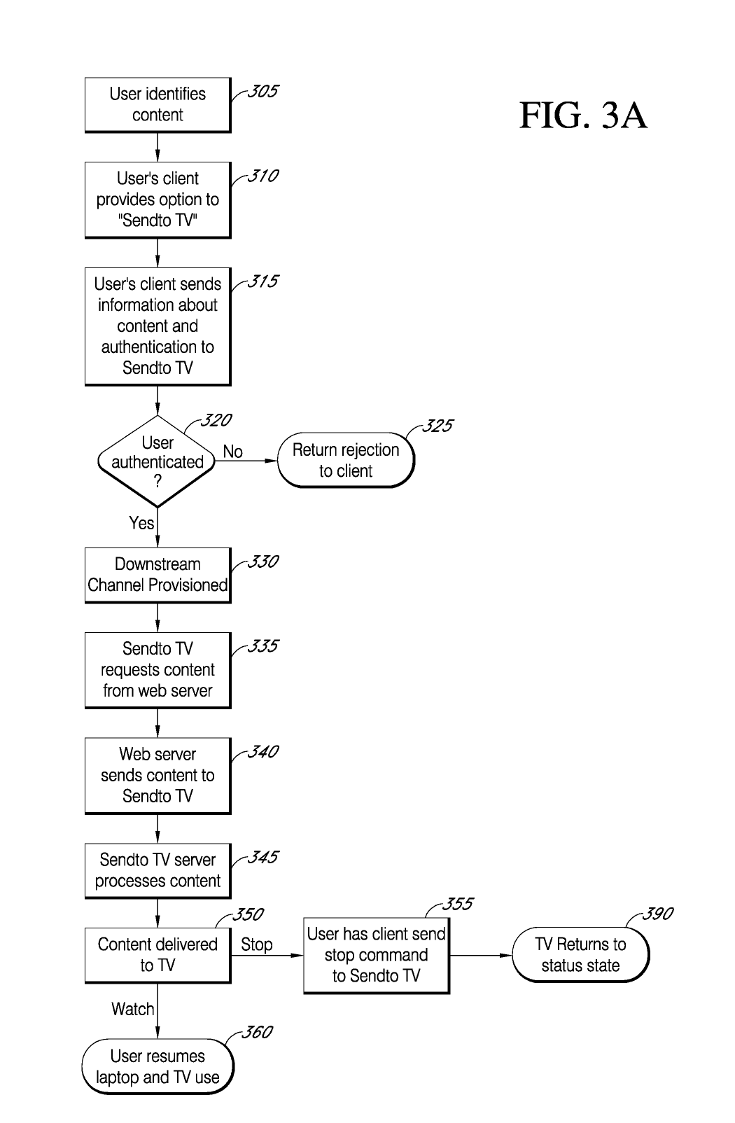

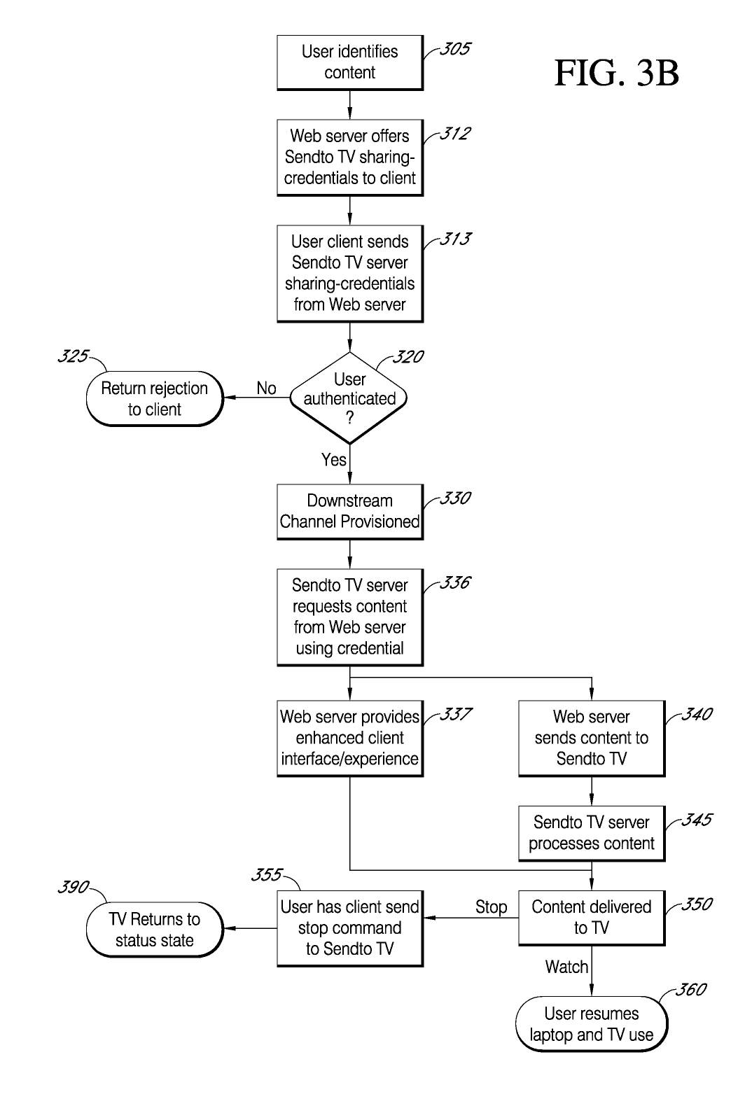

Referring now to FIGS. 3a and 3b, both figures illustrate processes by which network content is identified, requested, accessed, processed and delivered via cable television. FIG. 3a illustrates an unmediated process whereby the content is requested directly by the client. FIG. 3b illustrates a mediated process whereby the content is requested using a sharing credential mediated by the content host.

More specifically, FIG. 3a begins at a block 305, where a user identifies content of interest using an Internet capable device, such as a laptop computer, a smartphone, a tablet computing device, or another suitable device capable of connecting to the Internet. In one embodiment, the user obtains the URI through a web-browser. In another embodiment, the user identifies the content from a list of content. The list of content can contain items previously view by this user, items previously viewed by users with similar viewing patterns as this user, or popular items previously viewed by all users.

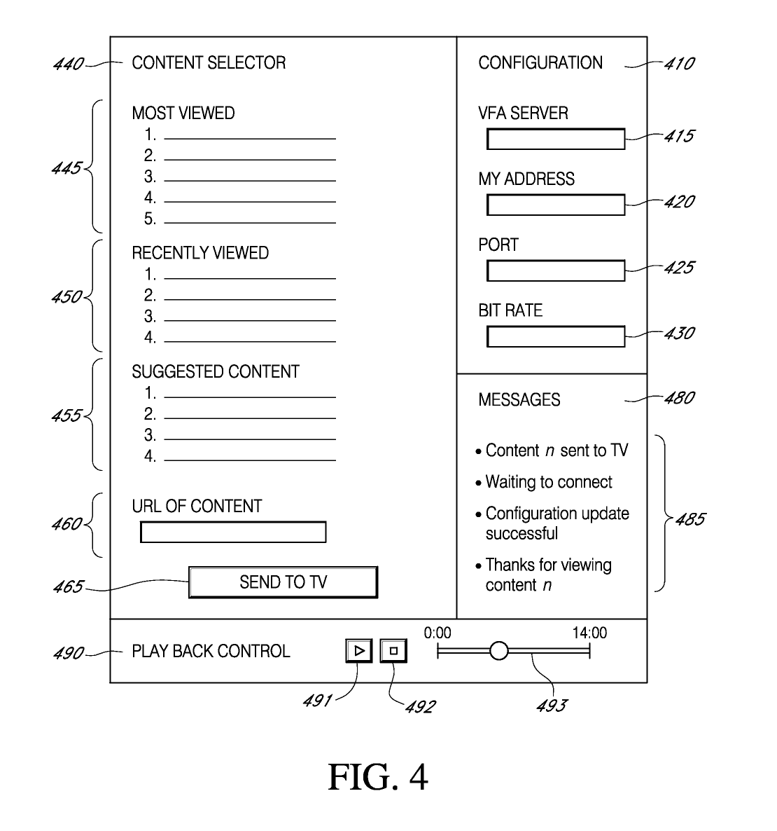

At a block 310, the user's client offers an option to send the content to their television. At a block 315, a signal is transmitted to the VFA server indicating the content that should be sent to television. The transmission selectively includes additional information along with a content URI. For example, information for accessing or viewing the content such as authentication credentials or preferences may be transmitted. Information to be used by the VFA server in may also be transmitted. In one embodiment, a user interface, like that shown in FIG. 4, is provided to mediate the transmission. In one embodiment, the user interface is implemented using a state-of-the-art interface technology such as a stand alone client, web-browser plug-in, or a hosted web-application.

At a block 320, the VFA server authenticates the user. If the authentication is unsuccessful, the process terminates at a block 325. If the authentication is successful, the VFA server provisions a downstream channel at a block 330. This downstream channel will be the channel the selected content is delivered to. For example, this provisioned channel is an unused video on demand channel.

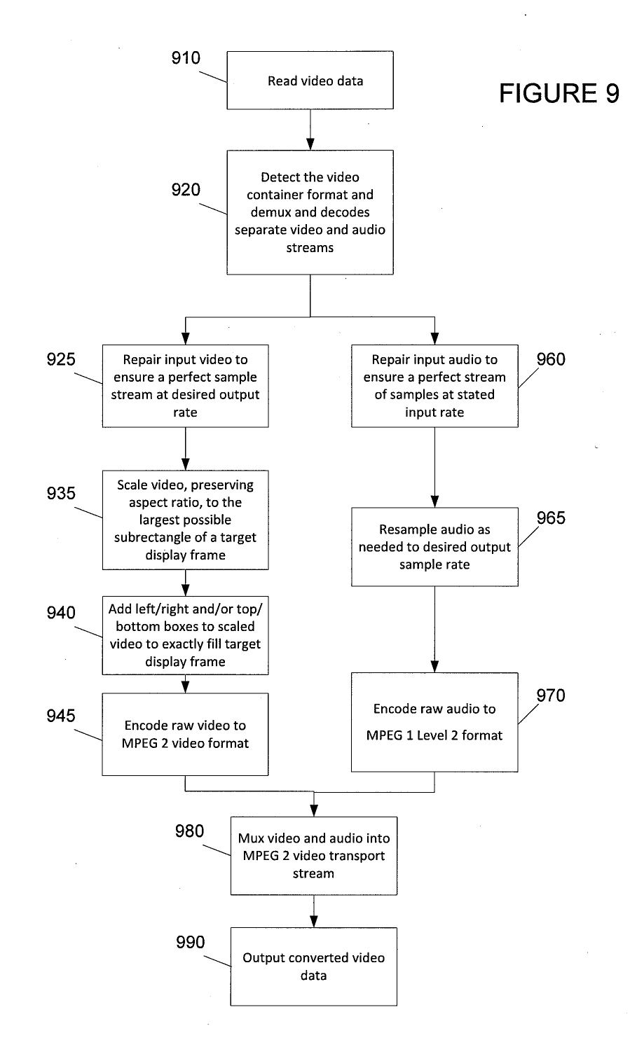

At a block 335, the VFA server requests content from the content location identified at block 305. At a block 340, the content identified at block 305 is sent from the content host to the VFA server. At a block 345, the VFA server processes the content, for example using a process as shown below in FIG. 9. At a block 350, the content identified at block 305 is delivered to the set-top box. In one embodiment, a signal is sent to the requesting client notifying the client to tune his STB to a particular channel to view the identified content. At a block 350, the user transmits signals controlling the playback of the identified content. In one embodiment, the signals are transmitted using a client graphical user interface. A block 355 is reached when the user transmits a stop signal to the VFA server indicating the user is finished watching the identified content. The process then terminates at a block 390 where the display system returns to its normal operating state. At this point, the process may be repeated, starting at block 300. Otherwise, the process terminates as the user arrives at a block 360, where the user resumes use of the display system and controller device.

In an embodiment where the client is a graphical user interface and the identified content contains a time element, controls directed toward playback of the content are selectively displayed. For example, at any point, a portion of the video's time line where the video has already been processed, and is therefore immediately watchable is shown on the slider in GREEN. The remainder of the video that has not been processed yet and is not yet viewable is shown on the slider in RED. The current playback position is shown on the slider as a BLACK bubble somewhere within the GREEN (watchable) region. With the passage of time, the GREEN (watchable) region grows and the RED (not watchable) region shrinks and eventually disappears. Initially, the playback position is set to the beginning point of the video time line, and playback is paused. The playback position is always constrained to lie within the GREEN (watchable region). When playback is paused, the interface allows movement of the current playback position on the slider to any position within the GREEN (watchable region), and the toggle control indicates that a press of the control activates playback. When playback is active, the BLACK bubble moves automatically to reflect the movement of the current playback position within the video time line, and the toggle control indicates that a press of the control pauses playback. Additionally, a “Stop Watching This Video” button control is displayed to terminate viewing the currently selected content. The client enables utilization of the toggle and slider controls with predictable and appropriate results, and acceptable response lag, for watching any desired portions of the watchable video region, with any desired pauses and activations of playback.

Referring now to FIG. 3b, the process diagram illustrates an alternate embodiment where the identified content is requested on behalf of a user in a mediated fashion. This process begins at a block 305, where a user identifies content of interest using an Internet capable device, such as a laptop computer, a smartphone, a tablet computing device, or another suitable device capable of connecting to the Internet. At a block 312, instead of the user's client offering to request the content as shown in block 310, the identified content host server offers to transmit the identified content and sharing credentials to the client. The sharing credentials enables a content provider to identify a specific VFA server request and a particular user pair. At a block 313, the user client sends the sharing credentials received from block 310 to the VFA server. At a block 320, the VFA server authenticates the user. If the authentication is unsuccessful, the process terminates at a block 325. If the authentication is successful, the VFA server provisions a downstream channel at a block 330. At a block 336, the VFA server requests content from the content location identified at block 305 using the sharing credentials from block 312. The content host, using the sharing credentials, provides an enhanced client interface and overall experience at a block 337. In one embodiment, the enhancements to the client interface include modifying the Internet capable device's display. Concurrently or in parallel with block 337, at a block 340, the content identified at block 305 is sent from the content host to the VFA server. At a block 345, the VFA server processes the content, for example using a process as shown below in FIG. 9. At a block 345, the content identified at block 305 is delivered to the set-top box. At a block 350, the user transmits signals controlling the playback of the identified content. A block 355 is reached when the user transmits a stop signal to the VFA server indicating the user is finished watching the identified content. At this point, the process may be repeated. Otherwise, the user arrives at a block 360, where the user resumes use of the display and client device and the process terminates.

Referring now to FIG. 4, an example of a user interface for generating signals to the system. In this embodiment, the interface presents four sub-panels 410, 440, 480, and 490. Sub-panel 410 is a configuration panel. This sub-panel 410 allows the client to be configured for communication with the VFA apparatus (not shown). In one embodiment, the configurable items includes the IP address of the VFA server 415, the clients IP address 420, associated port information 425, and a desired bit rate for the transmitted content 430.

Sub-panel 440 is a content selector panel. This panel enables selection of popular content 445, previously discovered content 450, content suggested based on previously discovered content 455, or entry of a new content URI 460. In one embodiment, the multi-media content resides at a remote network location. In another embodiment, the URI may refer to multi-media content stored on the controller device 170. A user selects at least one item from 445, 450, 455, or 460 and presses a button 465 to transmit the content URI over the network (not shown) to the VFA apparatus (not shown).

Interactions between the client and VFA server cause messages to be generated by the VFA server, the client, or the third party content owner which provide feedback for each command. Sub-panel 480 shows a messages panel for displaying messages 485. Examples of messages 485 include confirmation that a particular content has been sent to the television, errors in fetching the content, errors in communicating with the VFA server, or acknowledgement from the third party content provider.

Referring now to the playback sub-panel 490. The playback sub-panel 490 features controls 491, 492, 493 that allow user to affect the playback of the selected multimedia content. The controls on the interface transmit signals to the VFA server. The VFA server then transmits a corresponding signal to the transmission control unit at the provider system. Ultimately, this results in changing the state of playback of the selected multimedia content display.

In the example user interface shown in FIG. 4, the playback sub-panel 490 contains three controls 491, 492, and 493. The first control 491 starts and stops selected multimedia content. Pressing the control 491 while the selected content is not playing causes playback of the selected content to being. Pressing the control 491 while the selected content is currently playing causes playback of the selected content to stop.

The second control 492 terminates viewing of the selected multimedia content. A user selects control 492 when they are through viewing the selected multimedia content. Terminating viewing also signals the VFA server that the content is no longer needed and can be deleted or archived.

The third control 493 represents a timeline for the selected multimedia content. The control 493 displays a start and stop time representing the beginning and ending of the selected multimedia content. The timeline 493 can also contain an indicator that displays the present playback position of the selected multimedia content. As the selected multi-media content is played, the indicator advances to illustrate the relative position of the playback along the timeline 493. A user uses the control 493 to selects a given position on the timeline to initiate playback. During playback, a user may adjust the timeline indicator forward to advance the selected multimedia content to the indicated time. A user may adjust the timeline indicator back during playback to revert to a previous point in the multimedia content.

The playback sub-panels and controls are selectively displayed. If the selected multimedia content has not been adapted for viewing, and control them control may be disabled or hidden from the interface. Once the selected multimedia content has been adapted for viewing, controls may be enabled or displayed on the interface. In an embodiment of the system, the interface display is managed by software configured to operate on the controller device. In another embodiment, the interface display is managed by signals from the VFA server. In yet another embodiment, the interface display is managed by signals from the host of the multimedia content.

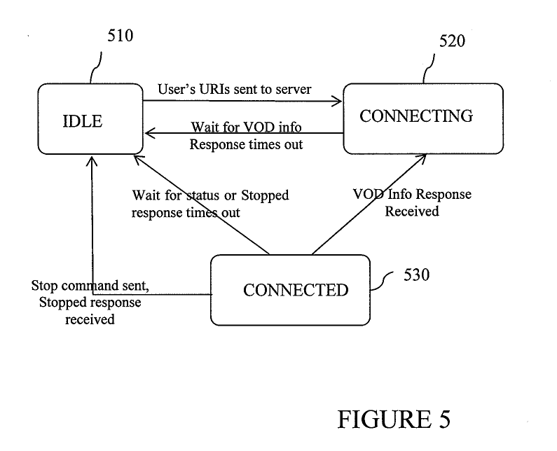

Referring now to FIG. 5, a state diagram illustrating the client disposition and the conditions changing the client disposition is shown. At block 510, the system is in an IDLE state. The client state changes to CONNECTING state 520 when content is identified and the client is ready to transmit information to the VFA server. In the CONNECTING state, shown at block 520, the VFA Client connects to a VFA Server, sends the content identification information and information to access and display the content, and waits for a response from the VFA Server. The connection from the VFA Client to the VFA Server has a timeout (the CONNECTION timeout). This timeout specifies a duration of time the VFA Client should wait to connect to the VFA Server. A second timeout specifies the duration of time the VFA Client should wait to receive a response from the VFA server after sending information to the VFA Server (the VOD INFO RESPONSE timeout). If the VFA Client cannot connect to the VFA Server or receive a response from the VFA Server within the specified timeouts, the connection, if any, with the VFA Server is closed, and the state transitions back to IDLE state 510.

If the VFA Client successfully connects to the VFA Server or receives a response from the VFA Server within the specified timeouts, a transition to the CONNECTED state occurs, as shown at 530. During this transition, a client user interface may be configured to show the response. In an embodiment of the system, a control containing the VOD channel field from the VOD Info Response is shown. Final transition to the CONNECTED state 530 occurs when the VFA Client transmits an acknowledgement of delivery of the requested content to the VFA server.

In the CONNECTED state, shown at 530, the VFA Client can transmit playback control signals or a terminate viewing signal to the VFA Server. The VFA Client submits these signals to the VFA Server and receives Status Responses from the VFA Server in parallel. In an embodiment of the system, a user selects the signal to be sent using a graphical user interface. Each time the user selects a playback control signal, the VFA Client transmits a Control Command with the requested control and waits for a Status Response corresponding to the transmitted Control Command. In an embodiment of the system, the graphical user interface alters the available options if waiting for a Status Response.

The VFA Client receives Status Responses with a minimum frequency (the STATUS_RESPONSE frequency). After sending a Control Command, there is a timeout to receive a matching Status Response (the STATUS_RESPONSE timeout). The fields in each Status Response received are reflected in the state of the playback state toggle and video time line controls shown to the user as soon as possible, except during the wait for a matching Status Response, when the contents of non-matching Status Responses are ignored. When the user presses the “Stop Watching This Video” button control, the VFA Client deactivates all controls, sends a Stop Command, and waits for a Stopped Response. While waiting for the Stopped Response, all Status Responses are accepted (but ignored). After sending a Stop Command, there is a timeout to receive a Stopped Response (the STOPPED_RESPONSE timeout).

Transition from the CONNECTED state 530 back to the IDLE state 510 occurs one of two ways: either the client does not receive a Status Response before the specified time out, or the VFA Client transmits a signal to the VFA Server terminating the use of the content. In an embodiment of the system, the graphical user interface selectively alters the display and available functions when the VFA Client transitions from the CONNECTED state 530 to the IDLE state 510. For example, the VFA Client may remove all available controls.

The VFA function as described herein has a client/server architecture. As described above, the client component comprises software that runs on the end user's PC or other computing device. The server portion comprises software that runs within the internal network of the cable provider.

The VFA Server 107 is responsible for interacting with the user in the client session. In the simplest form, the client session consists of a request from the user for particular video content to be displayed on the user's TV. The VFA server also authenticates the user's subscription and validates the request for service and sources of the requested video content and transcoding to video standards that are compatible with the set top box. The VFA server transmits the video content over the VOD channel to the particular user and communicates with the cable company back office systems for authentication, billing and activity recording as well as quality control.

Whenever the VFA server network service is running, it will listen for, accept, and process simultaneous TCP/IP network connections to its configured service socket address, up to a limit. Once a connection has been accepted, messages are exchanged between the client and the VFA server according to a protocol. In one embodiment, the protocol is a VFA Protocol. Messages passed between the client and the VFA server 107 during a session use the protocol. The protocol includes various commands sent from the client to the VFA server and various responses sent from the VFA server back to the client. The protocol is a specification for exchanging structured information in the implementation of the Client and the Server in a computer network. The protocol relies on an embedded coordinated universal time base and a distributed dual-screen logic to provide low latency, resilience, deterministic results and adaptation to available resources

The VFA server will listen for, accept, and handle or process control connections on a separate control socket address.

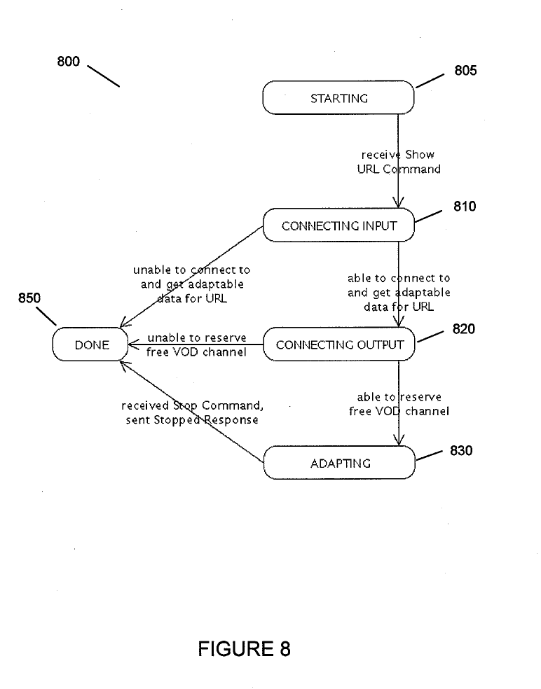

In one embodiment, the VFA server is stateless. A VFA server session may fail or the connection for it may be abandoned by either party at any time, without compromising the ability of the VFA server to accept and handle a subsequent connection from the same or another client. This is discussed further, in the discussion of the state diagram for the VFA server, FIG. 8.

The VFA server is multi-threaded, so that it can handle multiple simultaneous sessions with clients. Within a single session, the VFA server uses multiple threads of control while the session is the adapting state. In one embodiment, normal Java threading is used.

The VFA Server 107 will use the file system for caching video during an active session. However, this cached video does not persist beyond the life of a single session. Caching is used to improve the performance of embodiment that includes trich-play. Caching is used to temporarily store MM that is fetched or pre-fetched prior to delivery into downstream VFA pipeline processing stages. Cache hits improve performance and reduce latency at the expense of storage.

The video formatting adapter function requires sufficient memory to simultaneously store a queue of input buffers or frames and the corresponding output frames or buffers for each processing step along the video adaptation pipeline. The exact memory requirements are determined during development of the software according to the anticipated or pre-defined needs. In one embodiment, 250 MB of memory is required per session.

CPU usage for the VFA server may be significant with heavy concurrent usage. Experimentation has shown that the step that scales video up to high resolution, and the step that does MPEG 2 video encoding are extremely CPU intensive.

The VFA server may also benefit from fast memory I/O performance while writing and reading the cached video during each session. The VFA server 107 performs network I/O to clients at low rate. It will perform low-to-medium rate network I/O to download web videos from internet sources. It will also perform medium-to-high rate network I/O to send adapted video to the VOD Channel delivery point (in one embodiment, a UDP port).

In one embodiment, the VFA server is implemented as Linux multi-threaded network service. A client connects to a VFA server using a standard TCP/IP socket connection. Each VFA server instance can handle multiple simultaneous connections up to a configurable limit.

The main task of the VFA server during a session is to download and adapt the multi-media content stored at a particular URI, sending the adapted content to a delivery point. In one embodiment, the delivery point is a reserved multi-system operator VOD channel. In one embodiment, the VFA server uses a persistent data storage means for caching content.

In one embodiment, the VFA server contains a logging means. The logging means are configurable to store data about the system and its usage in real-time. For instance, the logging means can capture errors, or monitor system usage. In one configuration, the log data is written to a standard system file on a data storage device. In another configuration, the log data can be transmitted and stored by a relational database.

The VFA server is configurable. Examples of configurable parameters include the service socket address, the control socket address, timeouts, maximum connections, the logging level, and the server resources for processing allocated per client.

In one embodiment, the configuration information is stored in a data file. In another embodiment, the configuration information is provided to the VFA server at run-time. Should the VFA server fail to find configuration values, pre-defined default values will be used.

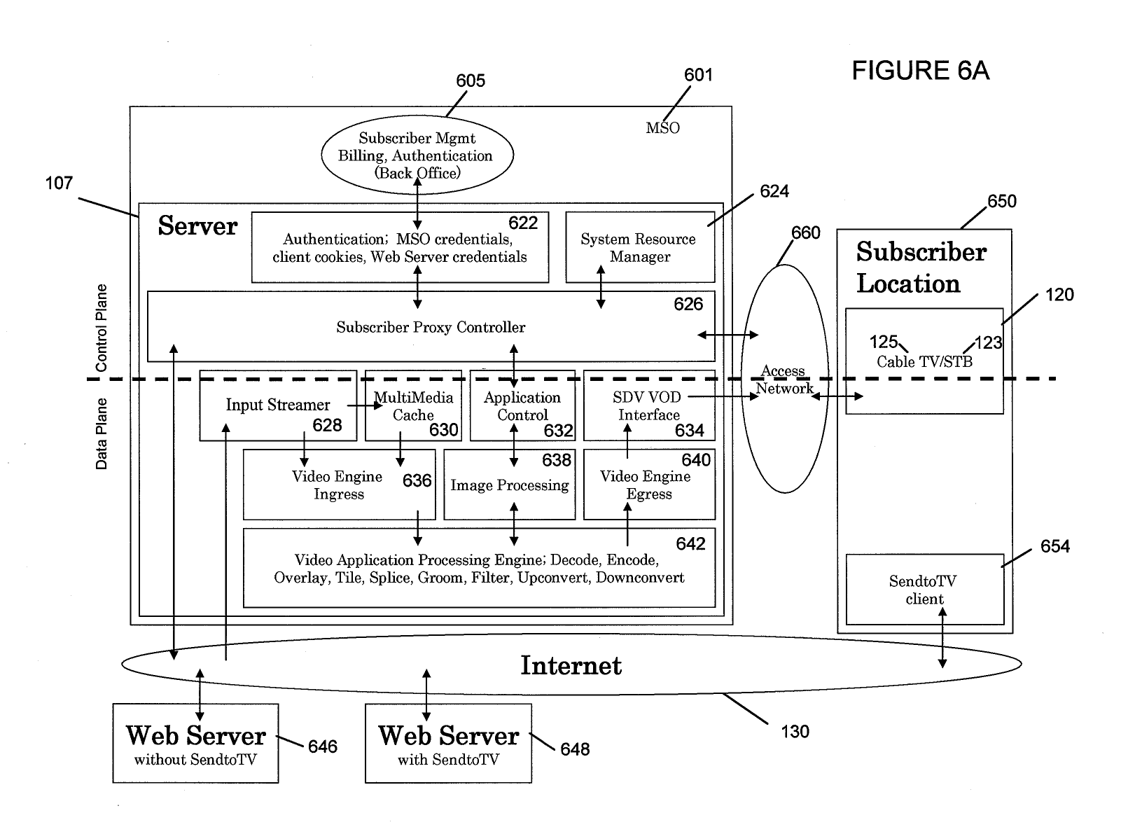

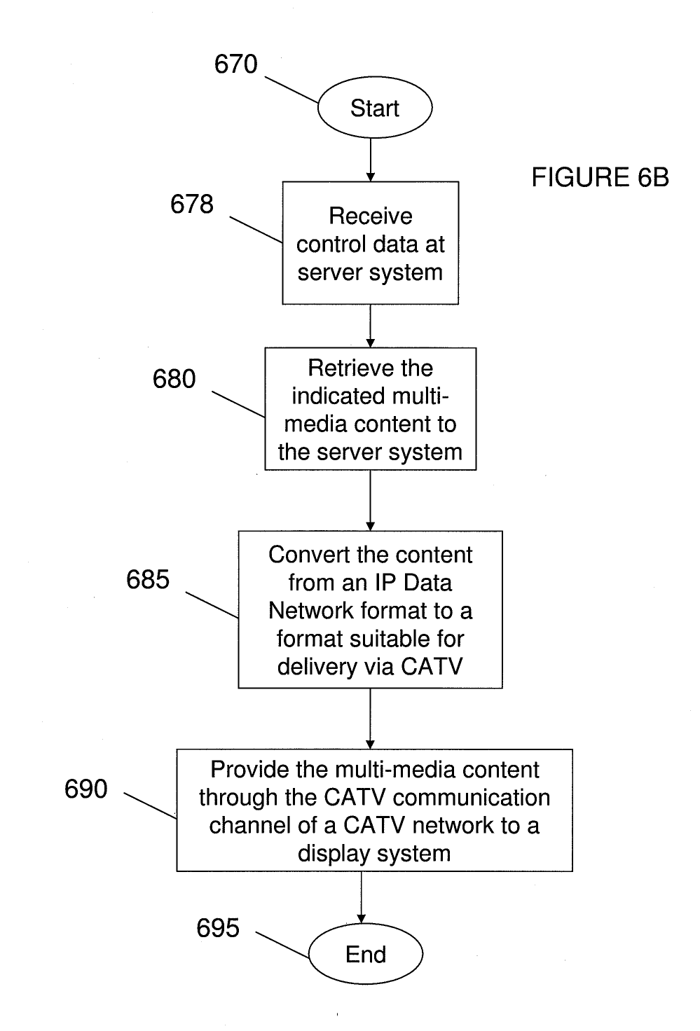

Referring now to FIG. 6A, a server sub-system component level diagram is shown. The system for delivering selections of multi-media content to an end user display 100 comprises the MSO sub-system 601, the CATV access network 110 and the subscriber location portion 650. The subscriber location portion 650 is further made up of cable TV/STB display module 125 and the client 654. The MSO 601 comprises a back office portion 605 and the VFA Server 107. The VFA Server 107 further includes the authentication; MSO credentials, client cookies Web server credentials 622, the system resource manager 624, the subscriber proxy controller 626, the input streamer 628, the multi-media cache 630, the application control 632, SDV VOD interface 634, transcode engine ingress 636, image processing 638, transcode engine egress 640, and parallel transcode application engine 642.

The STV system 100 is used in further conjunction with the Internet 130 and content 150 found on 646, 648.

With regard to VFA server portion 107, components as listed above are described as follows: The authentication and credentials portion 622 is responsible for authenticating user ids, devices ids, content ids, other various credentials and the like. The system resource manager 624 is responsible for tracking and managing the components working with the server 107 to run the system software. The subscriber proxy controller 626 receives requests from users(s), replies with messages and seeks authentication from the cable system back office data system 605. After authentication, this element sources the content (asset) 646, 648 from the Internet 130 and enables the input streamer 628 to accommodate the content. This element also interacts with the equipment of the CATV access network 110 to ensure VOD availability and switching from current VOD transmission, to the VFA server VOD output.

Input streaming 628 receives video content 150 from the Internet for delivery to memory (cache). Cache 630 processes the input stream and removes jitter from the stream. The transcode engine ingress 636: takes the de-jittered output from cache 630 and detects the ingress video standard for notification to the transcode application engine. The parallel transcode application engine 642 converts a variety of incoming assets having differing standards, to the video transmission standard that is used in the CATV access network 110. Usually, this output format is a standard known as MPEG-2. In other embodiments, the standard varies. The complexity of these elements results from having to convert multiple high speed bit streams having differing properties, for multiple users in real time. This conversion function is known in the industry as “transcoding.” After the transcoding function, the engine then streams the various video assets to the transcode engine egress element 640. The transcode engine egress 640 accepts the particular stream for the specific user for transmission to the user. The SDV/VOD interface 634 takes the output stream from the VFA server 107 and passes it to the CATV access network 110 having instituted a switch over from the normal VOD usage mode to the STV insertion mode. The CATV access network 110 transmits video content to subscribers over the either coaxial cable networks or over optical fiber based networks.

The application control 632 element accommodates a number of application-related commands and responds for a variety of uses. For example, this element comprises commands such as “stop” “pause” “play” etc. The controller processes these commands and responses and interfaces with image processing element 638 for image processing.

The subscriber location 650 comprises a display module 125, for example, a TV with cable service using a set-top box (STB) 123 and a user portable device such as a laptop, iPad, smart phone or other device that has Internet access. In one embodiment, the TV cable service should also provide a video on demand (VOD) channel although the methods described herein can use any channel that the cable company elects to use for the STV service. An alternate technology to the user selecting the VOD channel is auto detection of the current tuned channel and insertion over the channel with video content, thereby eliminating a requirement for user interaction with an STB remote control.

The Internet connection 130 is used for communication between the controller 170, for example, the user's portable device and VFA Server 107 located on the cable company premises. The portable device 170 can be used to set up the STV service by simply locating the cable company web site and following the subscription process after which the cable company will record the completion of the subscription. After this step the subscriber can use the internet to download a widget from the cable company website. The widget, when installed, will display an STV icon, for starting an internet client session as and when desired by the user. Although the basic use of the internet connection 130 is to provide a medium for the client session, in the basic mode video content is streamed to the user's TV over the access network, the internet also produces a connection over which the user can upload content such as locally stored video, photographs for files. The Internet service may or may not be provided by the cable company and although a wireless connection to the users' portable device makes the use of STV very convenient, it is not a requirement. Any form of connection to the Internet 130 will suffice.

Studies show that a large number of cable system subscribers use laptop or other portable devices while also watching television programs. There are many instances when users find content, on the Internet, using portable devices and wish to display the content on the large screen of a TV set. The method described herein and illustrated in FIG. 6B provides for this without any need for additional boxes or changes in the subscriber location equipment and preserves the normal operation of ancillary equipment such as digital video recorders (DVR).

When using the system, the method begins at block 678, where the user first locates the video content 150 of interest, then either drags the URI to the STV icon or while playing the video, simply clicks on the icon to send a request for the content to the VFA server 107. In this manner, the control data is received by at the server system via an IP Data Network from a controller device at a subscriber or end-user location. In one embodiment, the control data includes data indicative of selected multi-media content. The controller device may have a display screen and at least one processor and may be configured to present multi-media content on the controller screen and to transmit and receive signals from an IP Data Network. The control data indicates multi-media content to be provided by the provider system to a display system at the subscriber or end user location. Moving to block 680, the system 100 retrieves the indicated multimedia content into the server system. At block 685, the multi-media content is converted from an IP data network format to a data format suitable for delivery by the provider system through a cable television communication channel of a CATV network to the display system. The VFA server 107 accepts the request, authenticates the users' subscription and sources the video. If the VFA server 107 is already playing a video then the VFA server 107 messages the user accordingly, and the request is placed in a “line up” or queue. At block 690, the converted multi-media content is provided from the server system through the cable television communication channel of a CATV network to the display system. Videos are played down the user's VOD channel to the display device 125, for instance a TV, and messaging is sent to the users' portable device 170, requesting the user to switch the set top box 127 and the VOD channel. After the video has finished playing, the VFA server 107 will source and play the next video in the line-up or if no videos are scheduled, returns to normal VOD operation.

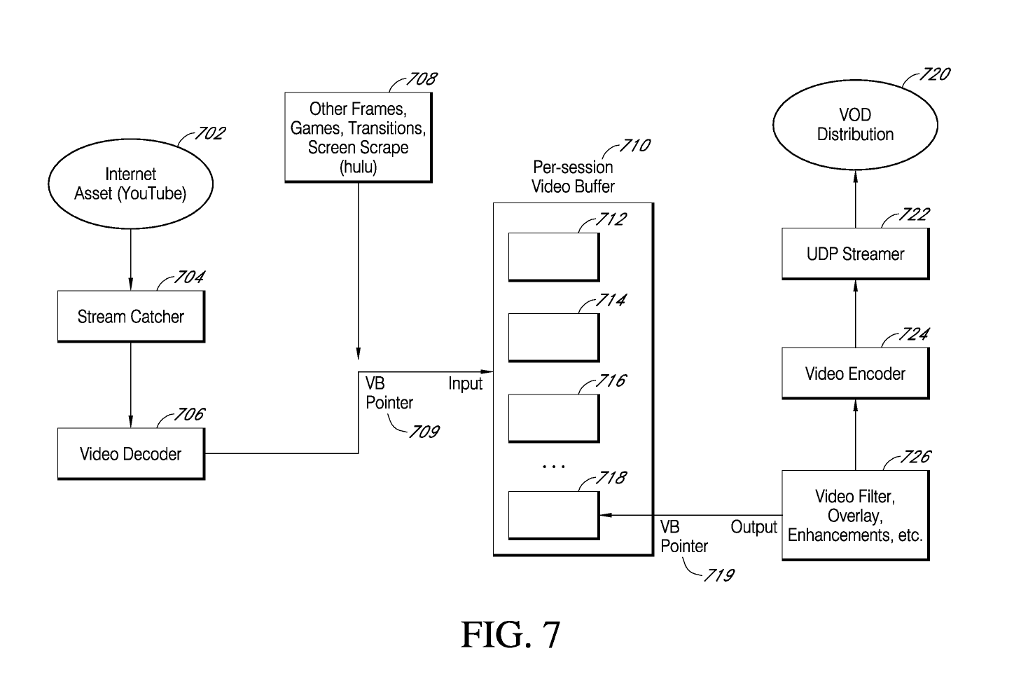

In FIG. 7, a process diagram illustrating the video buffer pipeline is shown. The video buffer pipeline includes the sources of video content 702, 708, for example, Hulu, You Tube, games, etc. This video from the content source continues downstream to the user datagram protocol stream “catcher” 704, where the pipeline formation begins with the transcode engine in 704, and continues to the video decoder 706, the video buffer input pointer 709, the per-session video buffer (“PVB”) 710, the VB output pointer 719, the video filter overlay 726, video encoder 724, UDP streamer 722 and VOD distribution point 720. The PVB 710, as shown, also comprises the video content frames, for example, as shown, 712, 714, 716 and 718.

Traditional VOD services are delivered to the subscriber from a VOD server in the headend on demand; in other words, a file is streamed when the user requests. The VOD programs are stored on the VOD server ahead of time and this is done using a catcher device. The catcher is responsible for moving video files from the programmer to the VOD server. In the current embodiment, the system 100 servers are just like a traditional VOD server except that the programs are never actually located in the headend but rather are accessed remote over the internet and only on demand by the user. In both VOD and system 100, the programs are sent in identical format to the user over the Hybrid Fiber Coax network to the set-top box.

For each simultaneous user, a continuous video stream (or per-session video buffer) or PVB is created in the server 107 and encoded for delivery in real time with absolute minimum latency. In one embodiment, the PVB 710 is continuously encoded in MPEG-2 HD at 5-18 Mbps with a minimum of latency and streamed out over UDP 722. This process may be computer power intensive.

Sources 702, 708 to the PVB include for example; internet video files, internet gaming sites, live video sites, and content aggregators. For example, remote video files are encoded in various formats including h264, HTML5, Silverlight, and FLV. The PVB is filled in real time from these various sources. Each simultaneous user PVB is filled in realtime. The interface between the remote video files and the PVB is a content aggregator such as YouTube or Hulu. All aggregators use standards based streaming protocols such as HTTP, Quicktime, or Silverlight. For example, each YouTube video subscriber requires the system 100 to fetch, decode, encode, and stream the video. The decoded images buffers support operations such as video transitions, filters, and overlays according to the system control messages. In another embodiment, the system 100 does not fetch the content, but rather the content provider runs the system client software on its own system that allows a user or viewer to choose to send the content to the system 100. For example, a user would see an icon on the display system 120 or controller 170 that would send the content right to the PVB 710 instead of to the catcher 704. This is shown in the flow of the content 708. In one example, interactive gaming sites will interface with the PVB 710 in multiple ways. In one embodiment, it may be that there are frame rendering and user commands exchanged between systems or it may be that some internet sites are rendered directly into the PVB frames.

For each subscriber flow the transcode engine (“XE”) constructs a pipeline starting with the input 704. The XE is the pipeline processing element for converting H.264 to MPEG-2. Separation between multiple inputs is done in the port 704. The listening server is threaded to handle these transactions. In one embodiment, the input bitrate per flow is up to 15 Mbps and therefore input network bitrate has the potential to be high. (15 Mbps*150=0.75 Gbps) In a more typical embodiment, the input bitrate is 3-5 Mbps input 704 per subscriber flow.

Since the input bitrate will vary, the amount of processing elements (PEs) required to decode will vary. The resource monitor (not shown) will allocate and schedule these PE resources.

The processing elements software may be loaded and optimized for the input encoded video format. Compressed video is buffered in memory which is available to the PEs. As transcode processing takes place, control and status are exchanged between the PE's and the Dispatch so that the subscriber flow can be administered (stop, start, rewind, etc).

The distributions of the processing elements (PEs) are arbitrary based upon the requirement for real-time transcoding. In other words, the XE does not have the requirement for file based faster than real-time Transcode. Only as many PEs as are required for real-time Transcode will be scheduled. Thus, it follows that an important metric in the system 100 is the number of PEs required for one subscriber flow.

Another important metric is the memory requirements for the fully uncompressed video per subscriber flow. It is important to perform zero-copy handoff between the decoder destination and the encoder source memory buffers.

The transcode encoder is configured for real-time web format input and HD MPEG-2 output. The output formats are for display on common MSO HD STB's., in other words MPEG-2 16:9 4-15 Mbps CBR.

Services for delivery input the multi-system operator (MSO) plant have a very tightly controlled specification, as described herein. If the services do not have these specifications, the equipment in-line for edge muxing 724 will not pass the video to the subscriber set-top box 123.

In one embodiment, for each subscriber flow the transcode engine constructs a pipeline ending with the UDP output 722. The separation point between multiple outputs is a multicast address, destination address and the UDP port.

The sending server is threaded to handle these multiple simultaneous transactions to the VOD distribution destination 720. The output bitrate per flow is up to 15 Mbps and therefore input network bitrate has the potential to be quite high. (15 Mbps*150=0.75 Gbps). A more typical rate is 3-5 Mbps UDP input per subscriber flow.

In FIG. 8, a state diagram illustrating the server disposition and the conditions changing the server disposition are shown. All sessions begin in the starting state 805 and end in the done state 850. From the starting state 805, the server transitions to the connecting input state 810 to the connecting output state 820 to the adapting state 830 to the done state 850. Abnormal processing at the connecting input 810 state, the connecting output 820 or the adapting state 830 may cause the server state to advance immediately to the done state 850, as described in detail, below.

At the starting state 805, so long as the VFA Server 107 is not already at its maximum for current sessions, the VFA Server 107 accepts a new connection attempt promptly enough that the client's connection timeout does not lapse.

The VFA Server 107 stays in the starting state 805 until it receives a Show URI Command, whereupon it transitions immediately to the connecting input state 810.

Once advanced to the connecting input state 810, the VFA Server 107 checks that it is able to obtain video data in an adaptable format. In one embodiment, the VFA Server 107 is able to adapt web video in Shockwave Flash Video format. In other embodiments, the server 107 is able to adapt video in other formats as well, such as Microsoft Silverlight Smooth Streaming Video or Apple HTTP Live Video. from the URI quickly (i.e. well within the client's VOD_INFO_RESPONSE timeout).

If the VFA Server 107 session fails from the connecting input state 810, as described above, the session will immediately transition to the done state 850. If the VFA Server 107 is successful in the connecting input state 810, the session will immediately transition to the connecting output state 820.

During the connecting output state 820, the VFA Server 107 will attempt to locate and reserve a free Cable VOD channel resource well within the client's timeframe window for a time out, for example field VOD_INFO_RESPONSE. In one embodiment, this process may always succeed with hard coded VOD Channel data. In another embodiment, this process involves interaction with a cable system's VOD server system.

If the VFA Server 107 session fails from the connecting output state 820, the session will immediately transition to the done state 850.

Under normal processing conditions, the connection output state 820 then transitions to the adapting 830 state, During the transition into the adapting state 830, the VFA Server 107 sends a response indicative of VOD information response data to the VFA Client with the VOD channel number and any other information needed for the user to tune to the VOD channel. This VOD info response comes promptly enough so that the client's timeout period does not lapse. Note that all of the work done by the VFA Server 107 for the session since receiving the Show URI Command up to sending the VOD information response is accomplished well within the timeout period. Once complete, the session immediately transitions into the adapting state. 830

During the adapting state 830, the VFA Server 107 may run several logical threads of control in parallel in the adapting state 830. The precise set of actual threads of control needed during the adapting state is determined during implementation. As described herein, the set of logical threads is approximately the minimum required. In another embodiment, it is advantageous to use additional threads. For example, the work performed by the adaptation thread might be performed by multiple actual threads, if doing so enhances performance. Rather than having just one adaptation thread that does a network-to-file adaptation, the system would have, for instance, one thread that performs the HTTP download, saving the result to a cache file, and another thread that uses that file as the input to a file-to-file adaptation. Three examples of threads, the adaptation thread, the delivery thread, and the service thread are described in the following paragraphs.

One logical thread of control, called the adaptation thread, may be devoted to reading web video input, adapting it, and caching it: The format of the incoming web video can be of any format; however, the adapted output will be an MPEG 2 transport stream, formatted for high resolution (for example, 720p in one embodiment and 1080i in another embodiment) at wide screen aspect ratio (for example, 16:9). Left/right side bars and/or top/bottom bars are used to adapt any other incoming aspect ratio. Adapted data will be cached on the VFA Server 107 for the most efficient support of user-controlled pausing and activation of playback as well as random selection of the playback position within the already-adapted portion of the video time line.

A separate logical thread of control, called the delivery thread, is devoted to reading adapted data from the cache and sending it to the appropriate delivery point for the VOD channel (for example, a UDP port). Whenever playback is currently active, the data stream for successive frames is sent successively. Whenever playback is currently paused, the video on the VOD channel will appear to have frozen on some recent I Frame. An I-Frame can be a complete image that the decoder preserves in the buffer. Typical video equals 30 frames per second, and MPEG allows B and P frames which contain vector estimates, rather than a complete picture. If all 30 frames were I frames, too much data would be sent. So I frames may only occur a few times within the 30 frame per second rate. The decoder can use this to paint a static picture during pause.

If the playback position reaches the end position of the video time line while playback is active during delivery, playback will pause, and the playback position will be reset to the beginning position of the video time line. If the playback position reaches the break point position between the GREEN (watchable) and RED (not watchable) portions of the video time line while playback is active during delivery, playback will pause, but the playback position will not change. Playback will be activated automatically later if and when a sufficiently wide gap opens up between the playback position and the break point position. The work done by the delivery thread will include maintaining coordination and correlation of the time stamps and continuity counter fields in the cached transport stream. It will also include delivering uncached material when playback is paused. This material will consist of “frozen” group of pictures (GOP) sequences that are formed from the most recent I Frame delivered prior to pausing. The cache comprises a well-formed transport stream. The stream that is delivered is well formed as well; however, if any pausing, resuming, or seeking is done under user control, the streams cannot be identical. During active playback, a single constant offset can be applied to all timestamps and a single phase shift applied to the continuity counter cycle. When playback is paused, GOP sequences using the last delivered I Frame is synthesized and delivered with appropriate timestamps and continuity counters values. In a manner that will vary with different Cable providers and different VOD Server systems, the VFA Server 107 may also have to interact with the VOD Server system. Essentially the VFA Server 107 is acting like a live program source with respect to the VOD Server system, and may need to announce RTSP meta data to it, or monitor channel change reports from it, or do other things.

The VFA Server 107 may also accept and handle “Control” and “Stop” commands from the VFA Client, and this processing will take place on a third logical thread of control called the service thread. Each control command will be processed, and playback will be paused or activated and the playback position moved in accordance with the user's request as recorded in the control command. The VFA Server 107 will send regular periodic status responses to the VFA Client. Each status response carries the serial ID from the most recent control command received and processed. Before any control commands have been received, status responses carry “0” for the serial ID. The VFA Server will send status responses so that the client receives them well within its STATUS_RESPONSE frequency limit. The VFA Server 107 will send a status response to each control command within the client's STATUS_RESPONSE timeout. The VFA Server 107 will send a Stopped Response to the eventual stop command within the client's STOPPED_RESPONSE timeout.

The VFA Server 107 stays in the adapting state 830 with the Adaptation, Delivery, and Service Threads running, until it receives a Stop Command and responds with a Stopped Response.

Once this command is received, the adapting state transitions to the done state 850. During the transition from the adapting state 830 to the done state 850, the VFA Server 107 will delete the cached video for the session. The session then immediately transitions to its terminal state, the done state 850.

In the done state 850, the VFA Server 107 will close the connection with the VFA Client and return all system resources used for the session before it ceases to exist.

Turning now to FIG. 9, one embodiment of a transcoding process is shown. At a block 910, source data is read. In one embodiment, the source data is read directly from the content provider. In another embodiment, the source data can be fetched from the third party content provider, stored at a second location from which the data is read at block 910. At a block 920, the video container format of the source data is determined and used to demux and decode the content into separate audio and video streams, as necessary. At this point, the process may transcode the video and audio signals separately, either in series or in parallel. Blocks 925, 1030, 935, 940, and 945 correspond to the video stream processing while blocks 960, 965, and 970 correspond to the audio stream processing.

Turning first to the video stream processing, at block 925, input video is repaired to ensure a perfect sample stream at desired output rate. At block 935, the video is scaled to the largest possible sub-rectangle of a target display frame while preserving the aspect ratio of the video. At block 940, left/right and/or top/bottom boxes are added to the scaled video to exactly fill target display frame. Then at block 945, the raw video is encoded to a suitable format, such as MPEG 2 video format.

Turning now to the audio stream processing, at a block 960, the audio input is first repaired to ensure a perfect sample stream at desired output rate. At a block 965, the audio input is re-sampled, as needed, to achieve the desired output sample rate. At a block 970, the raw audio is encoded to a suitable format, such as MPEG 1 Level 2 format.

At a block 980, the encoded video and audio streams are muxed into a suitable video transport stream, such as MPEG 2 video transport stream. At block 990, this video transport stream is outputted. In one embodiment, the output stream is outputted to a data storage device for transmission at a later time. In another embodiment, the output stream is transmitted directly to the STB for immediate display.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of providing multi-media content, comprising:
receiving control data at a server system of a cable television provider system via an IP Data Network from a controller device at an end-user location, the controller device having a display screen and at least one processor, and the controller device being configured to present multi-media content on the controller screen and to transmit and receive signals from an IP Data Network, wherein the control data indicates multi-media content to be provided by the provider system to a display system at the end-user location;
retrieving to the server system the indicated multi-media content;
converting the multi-media content from an IP Data Network format to a data format suitable for delivery by the provider system through a cable television communication channel of a CATV network to the display system; and
providing from the server system the converted multi-media content through the cable television communication channel of a CATV network to the display system.

2. The method of claim 1, wherein said data format suitable for delivery by the provider system through a cable television communication channel of a CATV network comprises Moving Picture Experts Group-2 (MPEG-2) format.

3. The method of claim 1, wherein converting the multi-media content comprises converting the multi-media content to MPEG-2 format video, and wherein said providing the converted multi-media content comprises providing the MPEG-2 format video to a set-top box in the display system at the end-user location.

4. The method of claim 1, wherein said data format suitable for delivery by the provider system through a cable television communication channel of a CATV network comprises H.264/Moving Picture Experts Group-4 format.

5. The method of claim 1, wherein the control device comprises any one of a laptop computer, a tablet computer, and a mobile device.

6. The method of claim 1, wherein said receiving control data comprises receiving the control device at the server system from the controller device through a communication path that includes a set-top box of the display system.

7. The method of claim 1, wherein the control data indicates where the multi-media content is available on the IP Data Network.

8. The method of claim 1, wherein the control data indicates a Universal Resource Name (URN) where the multi-media content can be retrieved.

9. The method of claim 1, further comprising providing a client application to the controller device for providing the control data to the multiple services operator.

10. The method of claim 5, wherein said receiving control data comprises receiving the control data from the client application running on the controller device.

11. The method of claim 1, further comprising
generating on the controller device the control data indicating the selected multi-media content for the provider system to provide to the display system at the end-user location;
sending the control data to the provider system via the IP Data Network; and
receiving on the display system the converted multi-media content from the provider system.

12. The method of claim 1, wherein the multi media content is provided to the display system though a connected video-on-demand (VOD) channel in real-time.

13. A system for providing multi-media data to an end user receiver, comprising:
a display system at an end-user location, the display system comprising a receiver capable of receiving multi-media content from a cable television communication channel of a CATV network;
a controller device at an end-user location, the controller device having at least one processor and a display screen for displaying multi-media content and configured to transmit and receive signals from an IP Data Network, the controller device further configured to generate control data indicating selected multi-media content to be provided to the display system and provide the control data over the IP Data Network to; and
a server system in a cable television provider system, the server system comprising
a receiving module configured to receive control data via an IP Data Network, the control data indicative of selected multi-media content to be provided by the provider system to the display system, and
a controller module configured to receive the selected multi-media content from the IP Data Network, convert the multi-media content from an IP Data Network format to a data format suitable for delivery by the provider system through a cable television communication channel, and provide the converted multi-media content through the cable television communication channel of the CATV network to the display system.

14. The system of claim 13, wherein display system further comprises a set-top box comprising the receiver.

15. The system of claim 13, wherein the controller module is configured to convert the multi-media content to MPEG-2 format video and provide the multi-media content in MPEG-2 format video to a set-top box of the display system.

16. The system of claim 13, wherein the display system comprises a set-top box, and wherein the controller device is configured to provide the control data to the cable television provider system through a communication path that includes a set-top box of the display system.

17. The system of claim 13, wherein the control data indicates where the selected multi-media content is available on the IP Data Network.

18. The system of claim 13, wherein the controller device comprises a client application for providing the control data to the multiple services operator.

19. The system of claim 13, wherein the cable television provider system is configured to provide the selected multi media content to the display system through a connected video-on-demand (VOD) channel in real-time.

20. The system of claim 13, wherein the control data comprises end-user information and
wherein the server system is configured to validate the end-user information.

21. A tangible computer readable medium having instructions stored thereon, the instructions comprising:
instructions for receiving control data at a server system of a cable television provider system via an IP Data Network from a controller device at an end-user location, the controller device having a display screen and at least one processor, and the controller device being configured to present multi-media content on the controller screen and to transmit and receive signals from an IP Data Network, wherein the control data indicates multi-media content to be provided by the provider system to a display system at the end-user location;
instructions for retrieving to the server system the indicated multi-media content;
instructions for converting the multi-media content from an IP Data Network format to a data format suitable for delivery by the provider system through a cable television communication channel of a CATV network to the display system; and
instructions for providing from the server system the converted multi-media content through the cable television communication channel of a CATV network to the display system.

22. A system for providing multi-media data to an end-user receiver, comprising:
means-for receiving control data at a server system of a cable television provider system via an IP Data Network from a controller device at an end-user location, the controller device having a display screen and at least one processor, and the controller device being configured to present multi-media content on the controller screen and to transmit and receive signals from an IP Data Network, wherein the control data indicates multi-media content to be provided by the provider system to a display system at the end-user location;
means-for retrieving to the server system the indicated multi-media content;
means-for converting the multi-media content from an IP Data Network format to a data format suitable for delivery by the provider system through a cable television communication channel of a CATV network to the display system; and
means-for providing from the server system the converted multi-media content through the cable television communication channel of a CATV network to the display system.
